(19) United States
(12) Patent Application Publication
(10) Pub. No.: US 2007/0103853 A1
(43) Pub. Date: May 10, 2007

(54) STRUCTURE FOR ASSEMBLING FLAT DISPLAY

(76) Inventor: Hung-Chen Kao, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,059

(22) Filed: Nov. 9, 2005

(51) Int. Cl. G06F 1/16

(52) U.S. Cl. 361/681; 345/173; 349/58

(57) ABSTRACT

Here provided is a structure for assembling a flat panel display in a notebook. A rear cover has a cross section of a wedge shape conformable to an LCD module so as to avoid using a conventional rectangular plastic mold frame by replacing it with the rear cover. Additionally, a conventional bezel is replaced with a front frame of the notebook. With such replacement, a structure and processes for assembling the flat panel display in the notebook can be significantly simplified without scarifying the advantage of the high compactness of the notebook computer to decrease a fabricating cost and the weight of the flat display.

### BACKGROUND OF THE INVENTION

1. Field of the Invention

The present invention relates to a flat panel display, and more particularly, to a structure for assembling a flat panel display for use in portable computers, such as: notebooks.

2. Description of Related Art

FIG. 1 illustrates a notebook including a conventional monitor 2 with a liquid crystal display (LCD) for displaying images. The monitor 2 having a rear cover 3 is coupled to a main body 1 of the notebook by using a hinge to make the monitor 2 rotate at any angle with respect to the main body 1. A LCD module 4 is fitted inside of the rear cover 3, fastened by tools like screws. A front frame 5 is mounted on the front surface of the LCD module 4.

Referring to FIG. 2, a detailed partial structure for assembling the conventional flat panel display is disclosed. The LCD module 4 with an attached bezel 8 (shown in FIG. 3) is first fastened to two brackets 7 that are connected to one side of a hinge 6 by tools such as: screws through an opening 7a of the two brackets 7. Likewise, the LCD module 4 with the attached bezel 8 is then fastened to the rear cover 3 by tools such as: the screws through an opening 7b of the two brackets 7. Accordingly, the LCD module 4 with the attached bezel 8 is secured to the brackets 7 and the rear cover 3 and then a front frame 5 of the notebook is disposed to cover the bezel 8 for forming the conventional monitor 2. Moreover, the main body 1 of the notebook is connected to another end of the hinge 6 so that the LCD module 4 can rotate at any angle with respect to the main body 1. However, during this convention assembling process, there occur many disadvantages that would deteriorate the performance of the monitor 2.

FIG. 3 is a perspective view of a line A-A′ shown in FIG. 1. When bolting the screws through the opening 7a, as shown in FIG. 3 and there is a gap G between the brackets 7 and the LCD module 4, a torque (as shown an arrow in FIG. 3) is caused, thereby effecting the bezel 8 clockwise rotate to come into contact with the display panel 40 of the LCD module 4 due to the rigid and thicker materials of the bracket 7. Consequently, pooling (or rippling) at the edge of the bezel 8 deteriorates the performance of the LCD module 4. Additionally, as illustrated in FIG. 3, the LCD module 4 comprises an upper polarized plate 41, the display panel 40, a lower polarized plate 44, a light guide plate 45, a reflector sheet 46 and a rectangular plastic mode frame 47 for fastening the preceding components as an integral unit, wherein the display panel 40 comprises an upper transparent substrate 42 and a lower transparent substrate 43 [0005] In the meantime, when bolting the screws through the opening 7b (i.e. the LCD module 4 fastened to the rear cover 3), the surface of the LCD module 4 does not engage well with the rear cover 3 and two sides of the LCD module 4 are already fastened to the bracket 7, another torque (as shown an arrow in FIG. 4) is therefore caused. As illustrated in FIG. 4, a stress is caused on the LCD module 4 due to the torque, thereby generating a pooling on the display panel 40 of the LCD module 4 when the monitor 2 is rotating with respect to the hinge 6.

As the front frame 5 of the notebook computer is required to cover the bezel 8, furthermore, the front frame 5 is not expected to cover an active area of the thin film transistor arrayed substrate 43. Accordingly, demand for the tolerance of an opening area surrounded by the front frame is more stringent. To meet the demand, manufacturers have made the tolerance of the gap between the front frame 5 and the preset display panel 40 loosed. However, this is contradictory to the compactness requirement of the monitor 2 of notebooks.

### SUMMARY OF THE INVENTION

Accordingly, the present invention is directed to a structure for assembling a flat panel display for use in a notebook computer, which uses less components, compared with a conventional flat panel display of the notebook computer, thereby considerably lowing the weight of the flat panel display of the notebooks. Furthermore, the flat panel display has a display module, such as: a LCD module for displaying images.

The present invention is further directed to provide the assembling process of a flat panel display for use in a notebook, which is greatly simplified over that of the conventional assembling of the flat panel display of the notebooks, thereby considerably reducing a fabricating cost of the flat panel display of the notebooks. Furthermore, the flat panel display has a display module, for example an LCD module for displaying images.

The present invention provides a structure for assembling a flat panel display of a notebook wherein a rear cover has a wedge-shaped cross section fitted into an LCD module so as to avoid using a conventional rectangular plastic mold frame by replacing it with the rear cover. Additionally, a conventional bezel is replaced with a front frame of the notebook. Accordingly, the structure for assembling the flat panel display in the notebook can be significantly simplified without scarifying the advantage of the high compactness, thereby reducing a fabricating cost and the weight of the flat panel display.

In one preferred embodiment of the present invention, in addition to a rear cover of a wedge-shaped cross section fitted into a LCD module, a rib is disposed on the circumference of the rear cover to serve as a securing block for securing the LCD module on the rear cover. In addition, the wedge shape has the same slope as that of the light-guided plate in the LCD module. Additionally, a conventional reflector sheet can be replaced by coating a high reflectivity paste on the surface of the rear cover having the wedge-shaped cross section.

In one preferred embodiment of the present invention, the structure for assembling a flat panel display in a notebook does not use the conventional bracket. Therefore, when assembling the flat display, the step of fastening the conventional bracket to the LCD module by screws are omitted; therefore, no torque is caused by the fastening step, thereby eliminating a pooling effect occurring on the flat panel display area of the notebook.

In one preferred embodiment of the present invention, the structure for assembling a flat panel display in a notebook is to dispose a panel controller in a main body of the notebook computer, instead of disposing the panel controller at the same space as the LCD module in the conventional flat panel display. Accordingly, in the present invention, signal lines connected to the LCD module pass through a signal-transmitting element, such as: flexible printed circuit (FPC) to the main body of the notebook, wherein, a pig-tail of the FPC passes through the space inside a hinge to considerably shorten the length of signal lines between the main body and the LCD module.

In one preferred embodiment of the present invention, as a front frame of a notebook replacing the conventional bezel, it is not necessary to enlarge the opening of the front frame of the notebook for covering the bezel. Additionally, as the components in the present invention are reduced, the tolerance of the opening surrounded by the front frame of the notebook can be more loosed. Hence, the loosed tolerance of the opening surrounded by the front frame of the notebook expedites the assembling process of the flat panel display for the notebook.

The objectives, other features and advantages of the invention will become more apparent and easily understood from the following detailed description of the invention when taken in conjunction with the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a notebook computer including a conventional flat panel display with a liquid crystal display (LCD).

FIG. 2 illustrates a part structure for assembling the conventional flat panel display, used to illustrate a process for assembling the conventional flat panel display unit.

FIG. 3 is a perspective view of a line A-A′ shown in FIG. 1, illustrating the conventional flat panel display.

FIG. 4 shows a torque on the display area of an LCD module caused after the LCD module fastened to a rear cover.

FIG. 5 is a perspective view of a structure for assembling flat panel display of one preferred embodiment of the present invention.

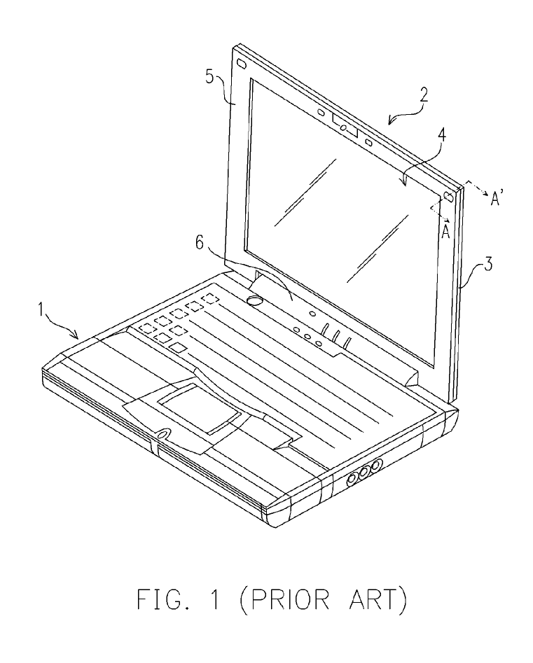

### DESCRIPTION OF THE EMBODIMENTS

Reference will now be made in detail to a structure for assembling a flat panel display for use in a notebook, examples of which are illustrated in the accompanying drawings. Wherever possible, the same reference numbers are used in the drawings and the descriptions to refer to the same parts.

Referring to FIG. 5, a perspective view illustrates a structure for assembling a flat panel display of one preferred embodiment of the present invention. Furthermore, the monitor of the notebook comprises a front frame 5, a display module 4, such as: a LCD module, for displaying images and a rear cover 3. The LCD module 4 comprising a display panel, which has an upper transparent substrate 42 and a lower transparent substrate 43, and a backlight module, which has a light guide plate 45, a reflector sheet 46, or other optical films. Essentially, the rear cover 3, connected to one end of a hinge 6, has a rib 9 disposed on the circumference of the inner surface of the front frame 5 so as to replace the conventional rectangular plastic mold frame 47, as shown in FIG. 3, and the rib 9 serves as a securing means for securing the backlight module and the rear cover 3 together. Meanwhile, another end of the hinge 6 is connected to the main body 1 of the notebook. Additionally, the conventional bezel 8 is replaced with a front frame 5 of the notebook. Accordingly, a structure for assembling the flat panel display in the notebook can be significantly simplified without scarifying the advantage of the high compactness, thereby reducing a fabricating cost and the weight of the flat display.

To secure the LCD module 4 to the rear cover 3, the rear cover 3 has a wedge-shaped cross section conformable to the LCD module 4, and the wedge shape has the same slope as the light-guided plate 45 in the backlight module. In addition, a conventional reflector sheet 46 can be replaced by coating a high reflectivity paste on the inner surface of the rear cover 3 with the wedge-shaped cross section.

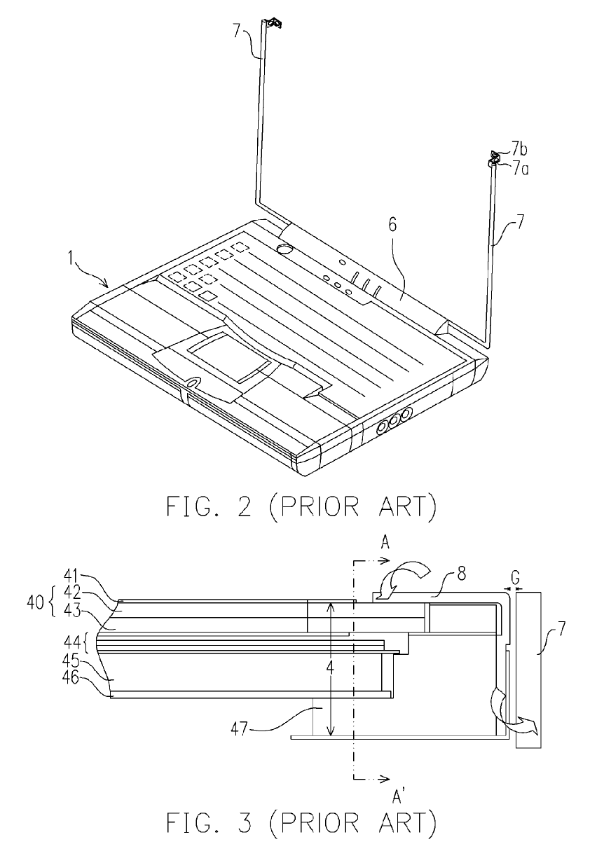

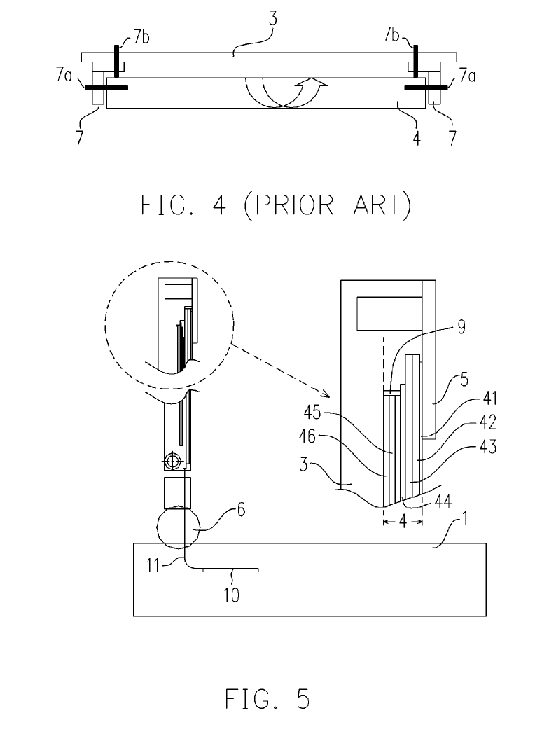

As illustrated in FIG. 5, the conventional brackets 7, in comparison with that of FIG. 2, are not used any more because, as described above, the LCD module 4 is secured to the rear cover 3 by using the rib 9, and the front frame 5 of the notebook replaces the conventional bezel 8. The front frame 5 can be directly in contact with or separated from the upper polarized plate 41 or the colour filter plate 42 with a gap less than 1 mm. In other words, front frame 5 and the rear cover 3 cooperatively secure the display panel and the backlight module together, and the LCD module 4 is integrated with the case of the notebook. Without the conventional brackets 7, the present invention does not have the aforementioned torque problem as a result of fastening the LCD module 4 to the brackets 7 by fastening screws through openings thereof. Consequently, the pooling (or rippling) at the edge of the bezel 8 as a result of the occurring of the torque, which deteriorates the performance of the LCD module 4, can be eliminated. Meanwhile, as the use of the conventional brackets 7 and bezel 8 is omitted in the present invention, a structure for assembling flat panel display is significantly simplified, which allow the present invention to have advantage of the high compactness of the flat panel display and lower a fabricating cost due to less assembling time as well as reduce the weight of the flat display.

Referring to FIG. 5, the structure for assembling the flat panel display in the notebook of the present invention disposes a circuit board for controlling the flat panel display, such as a time-controlling board 10, in the main body 1 of the notebook, instead of disposing the circuit board at the same space as the LCD module 4 in the conventional flat panel display. Accordingly, in the present invention, a signal transmitting element, such as a flexible printed circuit (FPC) 11, connecting driver chips packed on the thin film transistor arrayed substrate 43 to the time-controlling board 10, passes through the space inside the hinge 6. Furthermore, the length of signal lines for connecting a motherboard of the notebook disposed in the main body 1 to the time-controlling board 10 is considerably shortened.

Furthermore, in the present invention, as the front frame 5 of the notebook computer replacing the conventional bezel 8, the tolerance of the opening area surrounded by the front frame 5 of the notebook computer can be more loosed. Hence, the loosed tolerance of the opening area surrounded by the front frame 5 of the notebook expedites the assembling processes of the flat panel display in the notebook.

In summary, compared with the prior art, the structure for assembling the flat panel display of the present invention has the following advantages:

1. Without the conventional brackets, the present invention does not have the aforementioned torque problem when fastening the LCD module to the brackets by bolting screws through openings thereof. Moreover, since the brackets and bezel is not used in the present invention, a structure for assembling flat panel display is significantly simplified, which allow the present invention to have advantage of the high compactness of the flat panel display and reduce a fabricating cost due to less assembling time, as well as the weight of the flat display.

2. As the components in the present invention are reduced, the tolerance of the opening area surrounded by the front frame of the notebook can be more loosed. Hence, the loosed tolerance of the opening area surrounded by the front frame of the notebook expedites the assembling processes of the flat panel display in the notebook, which shortens the cycle time for assembling the flat panel display in the notebook and further reduces a fabricating cost.

3. The reflector sheet of the LCD module can be formed by coating a high reflectivity paste on the inner surface of the rear cover with a wedge-shaped cross section to help compact the flat panel display of the notebook.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A structure for assembling a flat panel display in a notebook, comprising:
a front frame;
a liquid crystal display module, comprising:
a display panel, having an upper transparent substrate and a lower transparent substrate, and the upper transparent substrate being partially covered by the front frame; and a backlight module; and
a rear cover, connected to one end of a hinge, comprising a securing means disposed on its inner surface for securing an optical film of the backlight module;
wherein the front frame and the rear cover cooperatively secure the display panel and the backlight module together so as to constitute the flat panel display, which is connected to a main body of the notebook by the hinge.

2. The structure of claim 1, wherein the liquid crystal module further comprises an upper polarized plate and a lower polarized plate respectively attached on the surfaces of the upper and the lower transparent substrates.

3. The structure of claim 1, wherein the upper transparent substrate is a color filter plate, and the lower transparent substrate is a thin film transistor arrayed substrate.

4. The structure of claim 1, wherein the optical film of the backlight module is a light guide plate.

5. The structure of claim 1, wherein the optical film of the backlight module is a reflector sheet.

6. The structure of claim 1, wherein a high reflectivity paste is coated on the inner surface of the rear cover.

7. The structure of claim 4, wherein the rear cover has a wedge-shaped cross section, and the rear cover and the light guide plate have the same slope.

8. The structure of claim 1, wherein a circuit board for controlling the flat panel display is disposed in the main body of the notebook.

9. The structure of claim 8, wherein a signal transmitting element for connecting the display panel to the circuit board disposed in the main body of the notebook passes through the space inside the hinge.

10. The structure of claim 9, wherein the signal transmitting element comprises a flexible printed circuit (FPC).

11. The structure of claim 2, wherein the front frame is directly in contact with the upper polarized plate of the liquid crystal module.

12. The structure of claim 1, wherein the front frame is directly in contact with the upper transparent substrate of the liquid crystal module.

13. The structure of claim 2, wherein the front frame is separated from the upper polarized plate or the upper transparent substrate with a gap less than 1 mm.

14. The structure of claim 1, wherein the securing means comprises a rib, a protrudent element, or a bracket.
